(19) United States
(12) Patent Application Publication
(10) Pub. No.: US 2024/0281770 A1
(43) Pub. Date: Aug. 22, 2024

(54) Cross-platform standardized maintenance method for power plant

(71) Applicants: Huaneng Jinan Huangtai Power Generation Co., Ltd., Jinan (CN); Shandong Huaneng Power Generation Co.,Ltd., Jinan (CN)

(72) Inventors: Jun Luan, Jinan, Shandong (CN); Xianchao Lu, Jinan, Shandong (CN); Yuling Wang, Jinan, Shandong (CN); Zhongyu Tian, Jinan, Shandong (CN); Rui Wan, Jinan, Shandong (CN); Kebing Wang, Jinan, Shandong (CN); Jianyong Ren, Jinan, Shandong (CN); Peng Sun, Jinan, Shandong (CN); Shuwen Leng, Jinan, Shandong (CN); Jie Li, Jinan, Shandong (CN); Xueli Li, Jinan, Shandong (CN)

(21) Appl. No.: 18/348,337

(22) Filed: Jul. 6, 2023

Related U.S. Application Data
(63) Continuation of application No. PCT/CN2023/096713, filed on May 29, 2023.

(30) Foreign Application Priority Data
Feb. 21, 2023 (CN) 202310138790.9

(51) Int. Cl. G06Q 10/20; G06Q 50/06

(52) U.S. Cl. CPC G06Q 10/20; G06Q 50/06

(57) ABSTRACT

A cross-platform standardized maintenance method for a power plant, including: construct the historical maintenance behavior of the corresponding power plant, set maintenance tags, carry out the behavioral consistency analysis on the tag setting results, then determine a plurality of first maintenance representations in the comprehensive maintenance set of consistent sub-behaviors, and extract high probability common representations from all the first maintenance representations corresponding to the same comprehensive maintenance set to construct standardized representations for the same consistent sub-behaviors; determine independent maintenance representations for inconsistent sub-behaviors based on the corresponding power generation platform, and construct the corresponding standardized representation based on the platform switching relationship; when maintenance is required, the maintenance switching mapping table with storage results consistent with that of the power plant to be maintained is automatically dispatched from the power plant cross platform to achieve standardized maintenance and effectively improve the maintenance efficiency.

### CROSS-REFERENCE TO RELATED APPLICATIONS

This application is a continuation of PCT/CN2023/096713, filed May 29, 2023 and claims priority of Chinese Patent Application No. 202310138790.9, filed on Feb. 21, 2023, the entire contents of which are incorporated herein by reference.

### TECHNICAL FIELD

The invention relates to the technical field of data processing, in particular to a cross-platform standardized maintenance method for a power plant.

### BACKGROUND ART

To ensure the normal operation of the power plant, it is necessary to often test various equipment of the power plant to timely eliminate the equipment defects and achieve good maintenance. However, the expression approaches of the final maintenance results are different due to the different rules and regulations of power plants in the maintenance process. It requires specialized personnel to repair and analyze, which undoubtedly reduce the maintenance efficiency.

Therefore, the invention provides a cross-platform standardized maintenance method for a power plant.

### CONTENT OF INVENTION

The invention provides a cross-platform standardized maintenance method for a power plant, which is used to collect the maintenance behaviors of different platforms and set tags, and standardize the consistent sub-behaviors and inconsistent sub-behaviors through behavior consistency analysis, realizing the unification of maintenance behaviors of different platforms, providing an effective basis for subsequent maintenance, and therefore improving the maintenance efficiency.

The invention provides a cross-platform standardized maintenance method for a power plant, which includes:

Step 1: Collect the historical maintenance data of different power plants based on own power generation platforms, and construct the historical maintenance behaviors of the corresponding power plants;

Step 2: Set maintenance tags for the historical maintenance behaviors of each power plant;

Step 3: Carry out the behavioral consistency analysis on all tag setting results, and extract consistent sub-behaviors and inconsistent sub-behaviors;

Step 4: Determine first maintenance representations for each first maintenance data in the comprehensive maintenance of each consistent sub-behavior based on the corresponding power generation platform, extract high probability common representations from all the first maintenance representations corresponding to the same comprehensive maintenance set, and construct standardized representations for the same consistent sub-behaviors based on the power plant cross platform;

Step 5: Determine independent maintenance representations for each inconsistent sub-behavior based on the corresponding power generation platform, and construct the standardized representation for each independent maintenance representation based on the platform switching relationship between the power plant cross platform and the own generation platform which is matched with the corresponding inconsistent sub-behavior;

Step 6: Store all standardized representations and the platform maintenance representations of own power generation platform that each standardized representation has a switching relationship;

When maintenance is required, the maintenance switching mapping table with storage results consistent with that of the power plant to be maintained is automatically dispatched from the power plant cross platform to achieve standardized maintenance.

Preferably, constructing the historical maintenance behaviors of the corresponding power plants includes:

Acquire the historical maintenance data recorded by the corresponding power generation platform of the same power plant;

Divide the historical maintenance data by the maintenance time to obtain a plurality of groups of maintenance data;

Carry out the behavioral analysis of each group of maintenance data based on the maintenance analysis model to obtain the first behaviors and the historical maintenance behaviors of the corresponding power plant.

Preferably, setting maintenance tags for the historical maintenance behaviors of each power plant includes:

Obtain all first behaviors of each power plant to analyze the behavior type of each first behavior of the same power plant and classify the behaviors, and establish the first maintenance line for each behavior type;

Meanwhile, establish the second maintenance line by the occurrence time of each first behavior for the same power plant;

Set the first sub-tag for the corresponding first maintenance line according to the comparison results between each first maintenance line and each second maintenance line;

Determine the behavior characteristics corresponding to the first behavior according to the self-maintenance process and self-maintenance data application of each first behavior in each first maintenance line, and construct the line characteristics based on the corresponding first maintenance line;

Set the second sub-tag for the corresponding first maintenance line based on the line characteristics;

Construct the maintenance tag of the corresponding power plant according to the first sub-tags and the second sub-tags of all the first maintenance lines.

Preferably, setting the first sub-tag for the corresponding first maintenance line according to the comparison results between each first maintenance line and each second maintenance line includes:

Obtain the number of behaviors existing on each first maintenance line, and determine the ratio A1 of the number of behaviors existing on the first maintenance line to the number of behaviors existing on the second maintenance line;

Analyze the time interval of adjacent behaviors on the same first maintenance line based on the probability prediction model, and predict the occurrence probability P1 of similar behaviors;

Recall the first mapping table matching the behavior type from the preset database in the case of A01≤A1<A02 and P1<P01, and extract the matching tag;

Recall the second mapping table matching the behavior type from the preset database in the case of A01≤A1<A02 and P1≥P0, and extract the matching tag;

Otherwise, recall the third mapping table matching the behavior type from the preset database, and extract the matching tag;

Wherein, the extracted matching tag is taken as the first sub-tag corresponding to the first maintenance line, A01 is the first comparison value, A02 is the second comparison value, and A01 is less than A02, and P01 is the probability comparison value.

Preferably, carrying out the behavioral consistency analysis on all tag setting results and extracting consistent sub-behaviors and inconsistent sub-behaviors include:

Match each first matching tag in the pending maintenance tag of the corresponding power plant with the second matching tag corresponding to the same type of maintenance behavior in each remaining power plant, and construct the matched array of each first matching tag;

Screen

$$[ \frac{N 1}{2} ] + 1$$

first behaviors randomly from the type behaviors matched by the corresponding first matching tag as the undetermined inconsistent behaviors when all array elements in the matched array are less than the first preset value;

Determine the number of first elements that meets the conditions and the number of second elements that does not meet the conditions when the array elements in the matched array are not less than the first preset value;

Screen

$$[ \frac{\frac{N 2}{N 3 + N 2} \times N 1}{N 1 + N 2 + N 3} ] + 1$$

first behaviors randomly from the type behaviors matched by the corresponding first matching tag as the undetermined inconsistent behaviors when the number of first elements is more than or equal to the number of second elements;

Screen

$$[ \frac{N 3}{N 3 + N 2} \times N 1 ]$$

first behaviors randomly from the type behaviors matched by the corresponding first matching tag as the undetermined inconsistent behaviors when the number of first elements is less than the number of second elements, where N1 represents the number of type behaviors matched by the first matching tag, N2 represents the number of first elements, and N3 represents the number of second elements;

Screen all overlapping undetermined inconsistent behaviors corresponding to each power plant, and extract the inconsistent sub-behaviors;

Screen a first behavior randomly from the same type of maintenance behaviors in each remaining power plant when none of the array elements in the matched array is less than the first preset value, and combine the first behavior with the behavior matched by the corresponding first matching tag, and each combined behavior is the corresponding consistent sub-behavior.

Preferably, determining first maintenance representations for each first maintenance data in the comprehensive maintenance of each consistent sub-behavior based on the corresponding power generation platform includes:

Acquire the first overhaul data of each consistent sub-behavior in the same comprehensive maintenance set;

Determine the power generation platform to which each first maintenance data belongs, and convert the corresponding first maintenance data into the first maintenance representation according to the platform-representation database.

Preferably, extracting high probability common representations from all the first maintenance representations corresponding to the same comprehensive maintenance set and constructing standardized representations for the same consistent sub-behaviors based on the power plant cross platform include:

Acquire the representation array of each first maintenance representation based on the representation analytic model, and the representation array comprises a plurality of representation symbols and the representation weighing of each representation symbol based on the corresponding first maintenance representation;

Acquire the occurrence number and weighing of the same representation symbol according to all representation arrays of the same comprehensive maintenance set, and obtain the common value corresponding to the same representation symbol;

$$G 1 = \frac{{\sum }_{j 1 = 1}^{m 1} {p}_{j 1}}{{\sum }_{j 1 = 1}^{m 1} {s}_{zong , j 1}} \times ln ( e + \frac{m 1}{m 2} )$$

Where, G1 represents the common value corresponding to the same symbol; m1 represents the occurrence number corresponding to the same symbol; m2 represents the total number of representation arrays contained in the same comprehensive maintenance set, and m2 is more than m1; Pj1 represents the occurrence weighing at the J1st occurrence of the same symbol; s_{zong,j1} represents the total array weighting of the representation array corresponding to the J1st occurrence of the same symbol, and s_{zong,j1} is more than Pj1; In represents the symbol of a logarithmic function; e represents a constant, which is 2.7;

Determine the symbols to be retained according to the common value, and regard the retained symbols as the high probability common representations;

Construct initial representations according to all high probability common representations contained in the same comprehensive maintenance set;

Obtain the remaining non-common representations in each representation array, uniformly represent the non-common representations of the same type of maintenance meaning according to the maintenance meaning of each remaining non-common representation and the public identification representation bias, and respectively establish the change relationship between the unified representation and the corresponding non-common representation in the same type of maintenance meaning;

Adjust the initial representation based on the unified representation to obtain the standardized representation, and establish the relational index to the corresponding change relationship.

Preferably, constructing the standardized representation for each independent maintenance representation based on the platform switching relationship between the power plant cross platform and the own generation platform which is matched with the corresponding inconsistent sub-behavior includes:

Obtain the first representation law of each own power generation platform and the second representation law of the power plant cross platform, and establish the platform switching relationship between the first representation law and the second representation law;

Standardize the corresponding independent maintenance representation based on the platform switching relationship, and obtain the standardized representation.

Other characteristics and advantages of the invention will be described in subsequent specification, and will become partially apparent from the specification or will be known by the implementation of the invention. The purpose and other advantages of the invention may be realized and obtained by means of the structure specifically indicated in the specification, the claims, and the drawings.

The technical proposal of the invention is further described in detail in the drawings and embodiments.

### DESCRIPTION OF DRAWINGS

The drawings are used to provide a further understanding of the invention, form part of the specification, are used to explain the invention together with the embodiments of the invention, and do not constitute a limitation to the invention. In the drawings:

FIG. 1 is the flowchart of a cross-platform standardized maintenance method for a power plant in the embodiment of the invention.

### EMBODIMENTS

The preferred embodiments of the invention are described below in conjunction with the drawings. It should be understood that the preferred embodiments described herein are used only to describe and explain the invention, but not to restrict the invention.

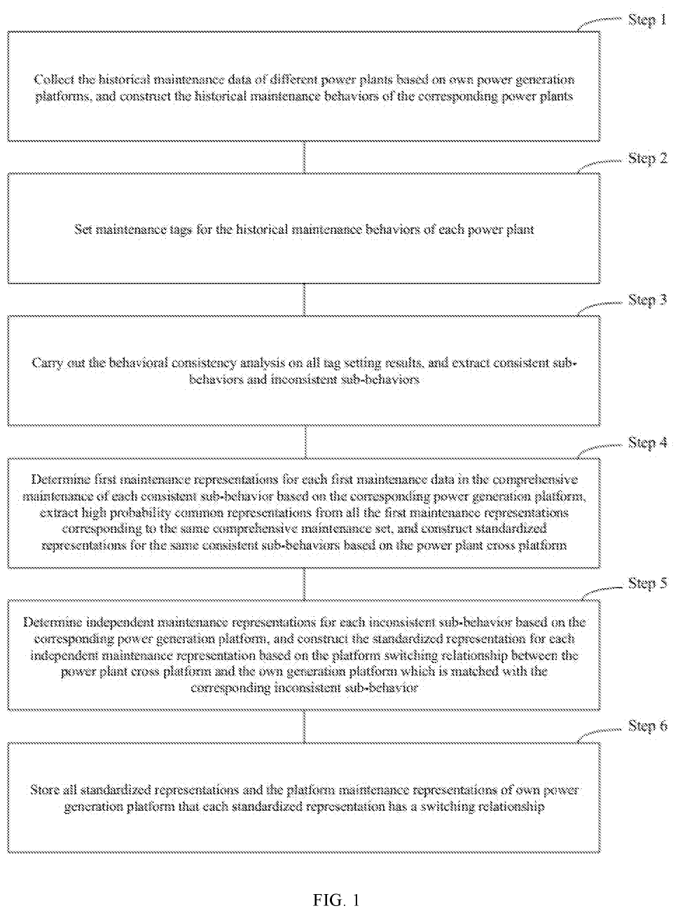

The invention provides a cross-platform standardized maintenance method for a power plant, as shown in FIG. 1, including:

Step 1: Collect the historical maintenance data of different power plants based on own power generation platforms, and construct the historical maintenance behaviors of the corresponding power plants;

Step 2: Set maintenance tags for the historical maintenance behaviors of each power plant;

Step 3: Carry out the behavioral consistency analysis on all tag setting results, and extract consistent sub-behaviors and inconsistent sub-behaviors;

Step 4: Determine first maintenance representations for each first maintenance data in the comprehensive maintenance of each consistent sub-behavior based on the corresponding power generation platform, extract high probability common representations from all the first maintenance representations corresponding to the same comprehensive maintenance set, and construct standardized representations for the same consistent sub-behaviors based on the power plant cross platform;

Step 5: Determine independent maintenance representations for each inconsistent sub-behavior based on the corresponding power generation platform, and construct the standardized representation for each independent maintenance representation based on the platform switching relationship between the power plant cross platform and the own generation platform which is matched with the corresponding inconsistent sub-behavior;

Step 6: Store all standardized representations and the platform maintenance representations of own power generation platform that each standardized representation has a switching relationship;

When maintenance is required, the maintenance switching mapping table with storage results consistent with that of the power plant to be maintained is automatically dispatched from the power plant cross platform to achieve standardized maintenance.

In this embodiment, each power plant has the corresponding power generation platform, which is named own power generation platform, and various maintenance operations and data for the power plant are recorded in the power generation platform.

In this embodiment, the historical maintenance data is acquired from the data recorded by the own power generation platform for the standardization of subsequent maintenance representations, ensuring that even non-professionals can realize effective maintenance of power plants and improving the maintenance efficiency.

In this embodiment, the historical maintenance data includes the maintenance records of different power generation equipment in the power plant, for example, the replacement of resistors in the equipment 1, or the connection of lines in the equipment 1, and other related data can be used as historical maintenance data.

In this embodiment, the maintenance tag is set according to the relevant historical maintenance behaviors, and different maintenances for different equipment or the same equipment will exist to determine the maintenance behaviors involved and reflect them in the form of a tag.

In this embodiment, the behavior consistency analysis is to determine the behavior analysis of different platforms on various maintenance behaviors, determine whether the maintenance behaviors are consistent sub-behaviors, analyze the behaviors involved in the power plant, and provide an effective basis for subsequent standardized representations.

In this embodiment, for example, there are power plants 1 and 2, the power plant 1 contains maintenance behaviors 11, 12 and 13, and the power plant 2 contains maintenance behaviors 21, 22 and 23. After the behavior consistency analysis, the existing consistent sub-behaviors are maintenance behaviors 11 and 22, and maintenance behaviors 12 and 22. Although the same maintenance behavior may be expressed in different ways on different platforms, the corresponding maintenance behavior can have the same behavior meaning. In this case, the corresponding inconsistent sub-behaviors are maintenance behaviors 13 and 23.

In this embodiment, each consistent sub-behavior will exist on multiple platforms, that is, a comprehensive maintenance set will be constructed, therefore the representation of each first maintenance data for the own power generation platform can be obtained. For example, the first maintenance behavior of the power plant 1 is represented as “@11 #11”; the first maintenance behavior of the power plant 2 is represented as “@11&11”; in this case, “@11 11” can be represented as a high probability, and “#” and “&” can be converted into more appropriate representations, such as “*”. At this point, the standardized representation is “@11*11”; the conversion relationship between the power plant cross platform and the corresponding platform of the power plant 1 is “*-#”, and the conversion relationship between the power plant cross platform and the corresponding platform of the power plant 2 is “*-&”.

In this embodiment, the platform switching relationship aims at the inconsistent sub-behaviors. For example, the representation of the inconsistent sub-behaviors for the power plant 1 is 998810%, and then the switching representation “ . . . ¥ ¥ 10∘” consistent with 998810% can be obtained according to the cross-platform switching relationship. The main purpose is to carry out the standardized representation and realize the standardized analysis of different maintenance behaviors to ensure the maintenance efficiency.

In this embodiment, the cross platform contains the maintenance representation of each own power generation platform and the switching relationship between the own power generation platform and the cross platform, easily ensuring the efficiency of subsequent maintenance through the standardization of behaviors.

In this embodiment, the maintenance switching mapping table is similar to 9 corresponding to “⋅”, 8 corresponding to “¥”, % corresponding to “∘”, etc.

The above technical proposal has the following beneficial effects: the standardized representation of the consistent sub-behaviors and inconsistent sub-behaviors is carried out by collecting the maintenance behaviors of different platforms, setting the tags and conducting the behavior consistency analysis, thereby unifying the maintenance behaviors of different platforms, providing an effective basis for subsequent maintenance and therefore improving the maintenance efficiency.

The invention provides a cross-platform standardized maintenance method for a power plant, which is characterized in that constructing the historical maintenance behaviors of the corresponding power plant includes:

Acquire the historical maintenance data recorded by the corresponding power generation platform of the same power plant;

Divide the historical maintenance data by the maintenance time to obtain a plurality of groups of maintenance data;

Carry out the behavioral analysis of each group of maintenance data based on the maintenance analysis model to obtain the first behaviors and the historical maintenance behaviors of the corresponding power plant.

In this embodiment, the historical maintenance data is recorded by the platform and includes maintenances for different equipment and the same equipment at different times.

In this embodiment, the maintenance data is divided by time, several groups of maintenance data can be obtained by dividing the maintenance data by two time points for the same maintenance because each maintenance has a start maintenance time point and an end maintenance time point.

In this embodiment, the maintenance analysis model is pre-trained and obtained by training based on different maintenance data and the behavior corresponding to the maintenance data as samples, and the relationship between the data and the behaviors is that the data is generated during a series of maintenances, but the behavior corresponding to the data is circuit connection behavior, which can also be understood as the behavioral response to the data.

The above technical proposal has the following beneficial effects: the historical maintenance behaviors can be effectively obtained by dividing the maintenance data by time and analyzing the data through the model, thereby providing a basis for the subsequent behavior consistency analysis.

The invention provides a cross-platform standardized maintenance method for a power plant, which is characterized in that setting the maintenance tags for the historical maintenance behaviors of each power plant includes:

Obtain all first behaviors of each power plant to analyze the behavior type of each first behavior of the same power plant and classify the behaviors, and establish the first maintenance line for each behavior type;

Meanwhile, establish the second maintenance line by the occurrence time of each first behavior for the same power plant;

Set the first sub-tag for the corresponding first maintenance line according to the comparison results between each first maintenance line and each second maintenance line;

Determine the behavior characteristics corresponding to the first behavior according to the self-maintenance process and self-maintenance data application of each first behavior in each first maintenance line, and construct the line characteristics based on the corresponding first maintenance line;

Set the second sub-tag for the corresponding first maintenance line based on the line characteristics;

Construct the maintenance tag of the corresponding power plant according to the first sub-tags and the second sub-tags of all the first maintenance lines.

In this embodiment, the first behaviors of the same power plant can be classified to obtain the maintenance lines with the same behaviors as maintenance will be conducted for accidents in the same power plant at different times, and the first maintenance line is mainly a behavior setting for the same behaviors.

In this embodiment, the second maintenance line is mainly a setting for the time when the maintenance behavior occurs.

In this embodiment, the comparison results between the first maintenance line and the second maintenance line are to set a time-related maintenance time tag for the first maintenance line. The self-maintenance processes and data application of the first behaviors refer to the maintenance-related processes in the maintenance process to obtain the behavioral characteristics of the first behaviors, and attach the behavioral characteristics to the maintenance line to obtain the line characteristics and then set the sub-tag for the first maintenance line. In this case, the setting of the sub-tag is the setting of the corresponding behavior operation characteristics to obtain the maintenance tag. In other words, the maintenance tag includes the maintenance time, maintenance process, operation and other contents representing the representations.

In this embodiment, the line characteristics are determined based on the first inspection line.

The above technical proposal has the following beneficial effects: the maintenance line can be effectively constructed for types by obtaining the first behaviors of the power plant and classifying the behaviors, the second maintenance line can be effectively established by judging the occurrence time, the first sub-tag can be set by comparing the lines, and then the second sub-tag can be easily set by analyzing and judging the behavior to obtain the maintenance tag. The main purpose is to provide a basis for the behavior consistency analysis and provide a basis for the subsequent improvement of maintenance efficiency.

The invention provides a cross-platform standardized maintenance method for a power plant, which is characterized in that setting the first sub-tag for the corresponding first maintenance line according to the comparison results between each first maintenance line and each second maintenance line includes:

Obtain the number of behaviors existing on each first maintenance line, and determine the ratio A1 of the number of behaviors existing on the first maintenance line to the number of behaviors existing on the second maintenance line;

Analyze the time interval of adjacent behaviors on the same first maintenance line based on the probability prediction model, and predict the occurrence probability P1 of similar behaviors;

Recall the first mapping table matching the behavior type from the preset database in the case of A01≤A1<A02 and P1<P01, and extract the matching tag; Recall the second mapping table matching the behavior type from the preset database in the case of A01≤A1<A02 and P1≥P0, and extract the matching tag;

Otherwise, recall the third mapping table matching the behavior type from the preset database, and extract the matching tag;

Wherein, the extracted matching tag is taken as the first sub-tag corresponding to the first maintenance line, A01 is the first comparison value, A02 is the second comparison value, and A01 is less than A02, and P01 is the probability comparison value.

In this embodiment, the number of behaviors on the second maintenance line can be the number of all first behaviors obtained from the corresponding power plant, and the number of behaviors on the first maintenance line is the number of the same type of first behaviors, then the ratio A1 is obtained, and A1 is equal to the number of behaviors on the first maintenance line divided by the number of behaviors on the second maintenance line.

In this embodiment, the probability prediction model is pre-trained and based on the occurrence number and time of different behaviors, and the probability is obtained based on the occurrence number and time, which are obtained by sample training. Therefore, the probability of occurrence of similar behaviors can be predicted.

In this embodiment, A01 is the first comparison value, A02 is the second comparison value, and A01 is less than A02.

In this embodiment, P01 is the probability comparison value;

In this embodiment, the preset database contains the mapping table matched by the maintenance behavior type of the corresponding first maintenance line, and then the corresponding tag can be matched from the mapping table by different judgment conditions.

The above technical proposal has the following beneficial effects: based on the judgment of the number of behaviors existing on the first and second maintenance lines and the prediction of occurrence probability based on the model, the matching tags are effectively extracted from the mapping table through the combination and comparison of the judgment conditions, providing a basis for the subsequent construction of maintenance tags.

The invention provides a cross-platform standardized maintenance method for a power plant, which is characterized in that carrying out the behavioral consistency analysis on all tag setting results and extracting consistent sub-behaviors and inconsistent sub-behaviors include:

Match each first matching tag in the pending maintenance tag of the corresponding power plant with the second matching tag corresponding to the same type of maintenance behavior in each remaining power plant, and construct the matched array of each first matching tag;

Screen

$$[ \frac{N 1}{2} ] + 1$$

first behaviors randomly from the type behaviors matched by the corresponding first matching tag as the undetermined inconsistent behaviors when all array elements in the matched array are less than the first preset value;

Determine the number of first elements that meets the conditions and the number of second elements that does not meet the conditions when the array elements in the matched array are not less than the first preset value;

Screen

$$[ \frac{\frac{N 2}{N 3 + N 2} \times N 1}{N 1 + N 2 + N 3} ] + 1$$

first behaviors randomly from the type behaviors matched by the corresponding first matching tag as the undetermined inconsistent behaviors when the number of first elements is more than or equal to the number of second elements;

Screen

$$[ \frac{N 3}{N 3 + N 2} \times N 1 ]$$

first behaviors randomly from the type behaviors matched by the corresponding first matching tag as the undetermined inconsistent behaviors when the number of first elements is less than the number of second elements, where N1 represents the number of type behaviors matched by the first matching tag, N2 represents the number of first elements, and N3 represents the number of second elements;

Screen all overlapping undetermined inconsistent behaviors corresponding to each power plant, and extract the inconsistent sub-behaviors;

Screen a first behavior randomly from the same type of maintenance behaviors in each remaining power plant when none of the array elements in the matched array is less than the first preset value, and combine the first behavior with the behavior matched by the corresponding first matching tag, and each combined behavior is the corresponding consistent sub-behavior.

In this embodiment, the pending maintenance tag is composed of the first tag and the second tag based on the same type of maintenance behaviors, that is, the tag is set based on the same type of sub-behaviors, and then the maintenance tag of the power plant is formed. In other words, the tags to be matched in the maintenance tags of each power plant are extracted, the tags of the same behaviors are compared with that of other power plants for analysis to extract the consistent and inconsistent sub-behaviors from the matched sub-behaviors.

In this embodiment, corresponding tags can be constructed for different types of behaviors in the same power plant, and tags 1, 2 and 3 exist. In this case, the tag 1 is matched with the tag 2 and 3 respectively to obtain the matched arrays: [tags 1-2, tags 1-3]. In this embodiment, the array element is the matching value of each element in the matched array, and the matching value is for the tags 1 and 2 or 1 and 3, and then a certain number of inconsistent behaviors are randomly screened by comparing the matching value with the preset value.

In this embodiment, meeting the conditions refers to meeting the condition that all array elements in the matched array are less than the first preset value, and failing to meet the condition is opposite to meeting the conditions.

In this embodiment, the matched array is [0.6, 0.8, 0.3, 0.5, 0.6], and the first preset value is 0.5. In this case, the number of first elements is 1, and the number of second elements is 4.

In this embodiment, the behaviors may overlap during the random screening process as the behaviors are extracted during the analysis of each matched array. Therefore, only one overlapping behavior is retained, that is, the overlapping behaviors are screened, and finally the retained behaviors are combined with the non-overlapping behaviors to obtain inconsistent sub-behaviors.

The above technical proposal has the following beneficial effects: the matched array is constructed by matching the tags, and the values of elements in the matched array are compared to facilitate random selection of behaviors, ensuring effective acquisition of consistent and inconsistent sub-behaviors as well as the efficiency of subsequent maintenance.

The invention provides a cross-platform standardized maintenance method for a power plant, which is characterized in that determining first maintenance representations for each first maintenance data in the comprehensive maintenance of each consistent sub-behavior based on the corresponding power generation platform includes:

Acquire the first overhaul data of each consistent sub-behavior in the same comprehensive maintenance set;

Determine the power generation platform to which each first maintenance data belongs, and convert the corresponding first maintenance data into the first maintenance representation according to the platform-representation database.

In this embodiment, each power generation platform has a dedicated representation, that is, each platform has a dedicated platform-representation database, from which the maintenance data can be converted to obtain the maintenance representation.

The above technical proposal has the following beneficial effects: the maintenance representations consistent with the maintenance data can be obtained from the database by obtaining the maintenance data of each sub-behavior, facilitating subsequent maintenance.

The invention provides a cross-platform standardized maintenance method for a power plant, which is characterized in that extracting high probability common representations from all the first maintenance representations corresponding to the same comprehensive maintenance set and constructing standardized representations for the same consistent sub-behaviors based on the power plant cross platform include:

Acquire the representation array of each first maintenance representation based on the representation analytic model, and the representation array comprises a plurality of representation symbols and the representation weighing of each representation symbol based on the corresponding first maintenance representation;

Acquire the occurrence number and weighing of the same representation symbol according to all representation arrays of the same comprehensive maintenance set, and obtain the common value corresponding to the same representation symbol;

$$G 1 = \frac{{\sum }_{j 1 = 1}^{m 1} {p}_{j 1}}{{\sum }_{j 1 = 1}^{m 1} {s}_{zong , j 1}} \times ln ( e + \frac{m 1}{m 2} )$$

Where, G1 represents the common value corresponding to the same symbol; m1 represents the occurrence number corresponding to the same symbol; m2 represents the total number of representation arrays contained in the same comprehensive maintenance set, and m2 is more than m1; Pj1 represents the occurrence weighing at the J1st occurrence of the same symbol; s_{zongj1} represents the total array weighting of the representation array corresponding to the J1st occurrence of the same symbol, and s_{zong,j1} is more than Pj1; In represents the symbol of a logarithmic function; e represents a constant, which is 2.7;

Determine the symbols to be retained according to the common value, and regard the retained symbols as the high probability common representations;

Construct initial representations according to all high probability common representations contained in the same comprehensive maintenance set;

Obtain the remaining non-common representations in each representation array, uniformly represent the non-common representations of the same type of maintenance meaning according to the maintenance meaning of each remaining non-common representation and the public identification representation bias, and respectively establish the change relationship between the unified representation and the corresponding non-common representation in the same type of maintenance meaning;

Adjust the initial representation based on the unified representation to obtain the standardized representation, and establish the relational index to the corresponding change relationship.

In this embodiment, the representation analysis model is pre-trained and obtained by training based on different maintenance representations and the symbols and weighting matched with the representations as samples, so that the corresponding representation arrays can be obtained.

In this embodiment, each representation array represents a row, and the representation symbols in each representation array are not identical.

In this embodiment, the corresponding representation symbol is retained when the common value is more than the preset value.

In this embodiment, for example, % ¥ in % ¥ # is a common representation, so that the initial representation is constructed based on % ¥, and # is the remaining non-common representation.

In this embodiment, public identification representation bias refers to representation which is more recognizable to ordinary citizens.

In this embodiment, change relationship refers to changing # to *, namely, #-*.

In this embodiment, standardized representation refers to standardizing different maintenance representations to obtain standardized representations for the purpose of cross-platform standard maintenance.

The above technical proposal has the following beneficial effects: the maintenance representation array is obtained through the model, the common value of the same representation symbols is calculated, and then the symbols to be retained are determined to achieve the initial construction of common representations. Moreover, the remaining non-common representations are adjusted to easily obtain the standardized representation, providing convenience for the subsequent maintenance representation and further ensuring the maintenance efficiency.

The invention provides a cross-platform standardized maintenance method for a power plant, which is characterized in that constructing the standardized representation for each independent maintenance representation based on the platform switching relationship between the power plant cross platform and the own generation platform which is matched with the corresponding inconsistent sub-behavior includes:

Obtain the first representation law of each own power generation platform and the second representation law of the power plant cross platform, and establish the platform switching relationship between the first representation law and the second representation law;

Standardize the corresponding independent maintenance representation based on the platform switching relationship, and obtain the standardized representation.

In this embodiment, the first representation law refers to the conventional representation of the corresponding platform, and then the conversion relationship between the first representation law and the second representation law is established based on the same maintenance meaning to achieve the standardization of the independent maintenance representation.

The above technical proposal has the following beneficial effects: the switching relationship between the own power generation platform and the power plant cross platform is established to facilitate the standardization of the independent maintenance representation to obtain the standardized representation, and ensure the efficiency of subsequent maintenance.

Obviously, the technicians in the field may make various alterations and variations of the invention without deviation from the spirit and scope of the invention. Thus, the invention is also intended to include such alterations and variations if they fall within the scope of the claims of the invention and their equivalent technologies.

1. A cross-platform standardized maintenance method for a power plant, characterized by including:
Step 1: Collect the historical maintenance data of different power plants based on own power generation platforms, and construct the historical maintenance behaviors of the corresponding power plants;
Step 2: Set maintenance tags for the historical maintenance behaviors of each power plant;
Step 3: Carry out the behavioral consistency analysis on all tag setting results, and extract consistent sub-behaviors and inconsistent sub-behaviors;
Step 4: Determine first maintenance representations for each first maintenance data in the comprehensive maintenance of each consistent sub-behavior based on the corresponding power generation platform, extract high probability common representations from all the first maintenance representations corresponding to the same comprehensive maintenance set, and construct standardized representations for the same consistent sub-behaviors based on the power plant cross platform;
Step 5: Determine independent maintenance representations for each inconsistent sub-behavior based on the corresponding power generation platform, and construct the standardized representation for each independent maintenance representation based on the platform switching relationship between the power plant cross platform and the own generation platform which is matched with the corresponding inconsistent sub-behavior;
Step 6: Store all standardized representations and the platform maintenance representations of own power generation platform that each standardized representation has a switching relationship;
When maintenance is required, the maintenance switching mapping table with storage results consistent with that of the power plant to be maintained is automatically dispatched from the power plant cross platform to achieve standardized maintenance;
Among the steps, constructing the historical maintenance behaviors of the corresponding power plants includes:
Acquire the historical maintenance data recorded by the corresponding power generation platform of the same power plant;
Divide the historical maintenance data by the maintenance time to obtain a plurality of groups of maintenance data;
Carry out the behavioral analysis of each group of maintenance data based on the maintenance analysis model to obtain the first behaviors and the historical maintenance behaviors of the corresponding power plant;
Among the steps, setting maintenance tags for the historical maintenance behaviors of each power plant includes:
Obtain all first behaviors of each power plant to analyze the behavior type of each first behavior of the same power plant and classify the behaviors, and establish the first maintenance line for each behavior type;
Meanwhile, establish the second maintenance line by the occurrence time of each first behavior for the same power plant;
Set the first sub-tag for the corresponding first maintenance line according to the comparison results between each first maintenance line and each second maintenance line;
Determine the behavior characteristics corresponding to the first behavior according to the self-maintenance process and self-maintenance data application of each first behavior in each first maintenance line, and construct the line characteristics based on the corresponding first maintenance line;
Set the second sub-tag for the corresponding first maintenance line based on the line characteristics;
Construct the maintenance tag of the corresponding power plant according to the first sub-tags and the second sub-tags of all the first maintenance lines;
Among the steps, extracting high probability common representations from all the first maintenance representations corresponding to the same comprehensive maintenance set and constructing standardized representations for the same consistent sub-behaviors based on the power plant cross platform include:
Acquire the representation array of each first maintenance representation based on the representation analytic model, and the representation array comprises a plurality of representation symbols and the representation weighing of each representation symbol based on the corresponding first maintenance representation;
Acquire the occurrence number and weighing of the same representation symbol according to all representation arrays of the same comprehensive maintenance set, and obtain the common value corresponding to the same representation symbol;
$$G 1 = \frac{{\sum }_{j 1 = 1}^{m 1} {p}_{j 1}}{{\sum }_{j 1 = 1}^{m 1} {s}_{zong , j 1}} \times ln ( e + \frac{m 1}{m 2} )$$
Where, G1 represents the common value corresponding to the same symbol; m1 represents the occurrence number corresponding to the same symbol; m2 represents the total number of representation arrays contained in the same comprehensive maintenance set, and m2 is more than m1; Pⱼ₁ represents the occurrence weighing at the J1^{st} occurrence of the same symbol; s_{zongj1} represents the total array weighting of the representation array corresponding to the J1^{st} occurrence of the same symbol, and s_{zongj1} is more than Pⱼ₁; In represents the symbol of a logarithmic function; e represents a constant, which is 2.7;
Determine the symbols to be retained according to the common value, and regard the retained symbols as the high probability common representations;
Construct initial representations according to all high probability common representations contained in the same comprehensive maintenance set;
Obtain the remaining non-common representations in each representation array, uniformly represent the non-common representations of the same type of maintenance meaning according to the maintenance meaning of each remaining non-common representation and the public identification representation bias, and respectively establish the change relationship between the unified representation and the corresponding non-common representation in the same type of maintenance meaning;
Adjust the initial representation based on the unified representation to obtain the standardized representation, and establish the relational index to the corresponding change relationship.

2. The cross-platform standardized maintenance method for the power plant according to claim 1, characterized in that setting the first sub-tag for the corresponding first maintenance line according to the comparison results between each first maintenance line and each second maintenance line includes:
Obtain the number of behaviors existing on each first maintenance line, and determine the ratio A1 of the number of behaviors existing on the first maintenance line to the number of behaviors existing on the second maintenance line;
Analyze the time interval of adjacent behaviors on the same first maintenance line based on the probability prediction model, and predict the occurrence probability P1 of similar behaviors;
Recall the first mapping table matching the behavior type from the preset database in the case of A01≤A1<A02 and P1<P01, and extract the matching tag;
Recall the second mapping table matching the behavior type from the preset database in the case of A01≤A1<A02 and P1≥P0, and extract the matching tag;
Otherwise, recall the third mapping table matching the behavior type from the preset database, and extract the matching tag;
Wherein, the extracted matching tag is taken as the first sub-tag corresponding to the first maintenance line, A01 is the first comparison value, A02 is the second comparison value, and A01 is less than A02, and P01 is the probability comparison value.

3. The cross-platform standardized maintenance method for the power plant according to claim 1, characterized in that carrying out the behavioral consistency analysis on all tag setting results and extracting consistent sub-behaviors and inconsistent sub-behaviors include:
Match each first matching tag in the pending maintenance tag of the corresponding power plant with the second matching tag corresponding to the same type of maintenance behavior in each remaining power plant, and construct the matched array of each first matching tag;
Screen
$$[ \frac{N 1}{2} ] + 1$$
first behaviors randomly from the type behaviors matched by the corresponding first matching tag as the undetermined inconsistent behaviors when all array elements in the matched array are less than the first preset value;
Determine the number of first elements that meets the conditions and the number of second elements that does not meet the conditions when the array elements in the matched array are not less than the first preset value;
Screen
$$[ \frac{\frac{N 2}{N 3 + N 2} \times N 1}{N 1 + N 2 + N 3} ] + 1$$
first behaviors randomly from the type behaviors matched by the corresponding first matching tag as the undetermined inconsistent behaviors when the number of first elements is more than or equal to the number of second elements;
Screen
$$[ \frac{N 3}{N 3 + N 2} \times N 1 ]$$
first behaviors randomly from the type behaviors matched by the corresponding first matching tag as the undetermined inconsistent behaviors when the number of first elements is less than the number of second elements, where N1 represents the number of type behaviors matched by the first matching tag, N2 represents the number of first elements, and N3 represents the number of second elements;
Screen all overlapping undetermined inconsistent behaviors corresponding to each power plant, and extract the inconsistent sub-behaviors;
Screen a first behavior randomly from the same type of maintenance behaviors in each remaining power plant when none of the array elements in the matched array is less than the first preset value, and combine the first behavior with the behavior matched by the corresponding first matching tag, and each combined behavior is the corresponding consistent sub-behavior.

4. The cross-platform standardized maintenance method for the power plant according to claim 1, characterized in that determining first maintenance representations for each first maintenance data in the comprehensive maintenance of each consistent sub-behavior based on the corresponding power generation platform includes:
Acquire the first overhaul data of each consistent sub-behavior in the same comprehensive maintenance set;
Determine the power generation platform to which each first maintenance data belongs, and convert the corresponding first maintenance data into the first maintenance representation according to the platform-representation database.

5. The cross-platform standardized maintenance method for the power plant according to claim 1, characterized in that constructing the standardized representation for each independent maintenance representation based on the platform switching relationship between the power plant cross platform and the own generation platform which is matched with the corresponding inconsistent sub-behavior includes:
Obtain the first representation law of each own power generation platform and the second representation law of the power plant cross platform, and establish the platform switching relationship between the first representation law and the second representation law,
Standardize the corresponding independent maintenance representation based on the platform switching relationship, and obtain the standardized representation.
